(19) United States
(12) Patent Application Publication
(10) Pub. No.: US 2025/0170701 A1
(43) Pub. Date: May 29, 2025

(54) ASSISTING DEVICE

(71) Applicant: JTEKT CORPORATION, Kariya-shi (JP)

(72) Inventors: Hiromichi OHTA, Kariya-shi (JP); Yuki KOBAYASHI, Nara-shi (JP); Takeshi KOYAMA, Neyagawa-shi (JP); Yoshinori WADA, Kashiba-shi (JP); Madoka HATTORI, Nara-shi (JP)

(73) Assignee: JTEKT CORPORATION, Kariya-shi (JP)

(21) Appl. No.: 18/842,090

(22) PCT Filed: Mar. 3, 2022
(86) PCT No.: PCT/JP2022/009215

§ 371 Date: Aug. 28, 2024

(51) Int. Cl. B25J 9/00; B25J 9/10

(52) U.S. Cl. CPC B25J 9/0006; B25J 9/1045

(57) ABSTRACT

An assisting device 10 includes a first harness 11 that is fit on at least shoulders BS of a user, a second harness 12 that is fit on each of right and left legs BL of the user, a third harness 40 that is fit on a waist BW of the user, a belt body 13 that is provided along a back of the user, spanning the first harness 11 and the second harness 12, an actuator 14 that is provided in the first harness 11 and that enables a portion of the belt body 13 to be taken up and fed out, and a back frame 44 that connects the first harness 11 and the third harness 40 at the middle of the back of the user, and maintains a spacing therebetween. An outer side face 44c of the back frame 44 that faces away from the user includes a first sliding contact face 48 over which the belt body 13 slides in contact therewith.

### TECHNICAL FIELD

The present invention relates to an assisting device.

### BACKGROUND ART

For example, Patent Document 1 discloses an assisting device that includes a first harness that is fit to the back of a user, a second harness that is fit to right and left legs of the user, a belt body that is provided along the back side of the user spanning between the first harness and the second harness, and an actuator provided on the first harness. This assisting device generates tensional force in the belt body by taking up a portion of the belt body with the actuator. This tensional force acts on the user as an assisting force.

The assisting device also includes a support mechanism for supporting the body of the user. This support mechanism is a mechanism for efficiently applying the tensional force of the belt body as the assisting force to the waist of the user. The support mechanism includes a waist attachment body that is fixed to the waist of the user, a back attachment body that is included in the first harness, and a holding body that connects the waist attachment body and the back attachment body and maintains a spacing therebetween. This holding body includes a pair of frames that connect the waist attachment body and the back attachment body on both right and left sides of the body of the user.

### RELATED ART DOCUMENTS

### Patent Documents

Patent Document 1: Japanese Unexamined Patent Application Publication No. 2021-49601 (JP 2021-49601 A)

### SUMMARY OF THE INVENTION

### Problem to be Solved by the Invention

The pair of frames of the conventional assisting device described above are disposed on both the right and left sides of the body of the user. Accordingly, there were situations in which movements of the user were impeded, due to interference between the arms of the user and the pair of frames, and movements of the user being significantly restricted.

### Means for Solving the Problem

An assisting device that is an embodiment, an assisting device that is an embodiment, includes a first harness that is fit on at least shoulders of a user, a second harness that is fit on each of right and left legs of the user, a third harness that is fit on a waist of the user, a belt body that is provided along a back of the user, spanning the first harness and the second harness, an actuator that is provided in the first harness and that enables a portion of the belt body to be taken up and fed out, and a back frame that connects the first harness and the third harness at the middle of the back of the user, and maintains a spacing therebetween. A first face of the back frame that faces away from the user includes a first sliding contact face over which the belt body slides in contact therewith.

### Effects of the Invention

According to the present disclosure, impeding movements of a user can be suppressed.

### BRIEF DESCRIPTION OF THE DRAWINGS

FIG. 1 is a rear view of an assisting device according to an embodiment, illustrating a state of attachment thereof to a body of a user.

FIG. 2 is an explanatory diagram illustrating a state in which the user fitted with the assisting device is in a forward leaning posture.

FIG. 3 is an enlarged view of principal portions of a rear face of the assisting device.

FIG. 4 is a diagram illustrating moment acting on the user in a forward leaning posture.

FIG. 5 is an enlarged view of principal portions of the rear face of the assisting device.

FIG. 6 is a schematic diagram illustrating a cross-section of a holding body and a protective member.

FIG. 7 is a diagram of a second harness in a state of being fit on a right leg of the user, as viewed from the rear face.

FIG. 8 is a diagram of the second harness in a state of being fit on the right leg of the user, as viewed diagonally from the front.

FIG. 9 is a diagram illustrating a holding body according to another embodiment.

FIG. 10 is a cross-sectional view taken in the direction of arrows on line A-A in FIG. 9.

FIG. 11 is a cross-sectional view taken in the direction of arrows on line B-B in FIG. 9.

### MODES FOR CARRYING OUT THE INVENTION

First, contents of embodiments will be listed and described.

### Overview of Embodiments

(1) An assisting device that is an embodiment includes a first harness that is fit on at least shoulders of a user, a second harness that is fit on each of right and left legs of the user, a third harness that is fit on a waist of the user, a belt body that is provided along a back of the user, spanning the first harness and the second harness, an actuator that is provided in the first harness and that enables a portion of the belt body to be taken up and fed out, and a back frame that connects the first harness and the third harness at the middle of the back of the user, and maintains a spacing therebetween. A first face of the back frame that faces away from the user includes a first sliding contact face over which the belt body slides in contact therewith.

According to the above configuration, having the back frame that connects the first harness and the third harness enables the spacing between the first harness that is fit to the back and the third harness that is fit to the waist to be maintained without placing structures such as frames or the like on both right and left sides of the body of the user. As a result, impeding of movements of the user can be suppressed. Also, the back frame has the first sliding contact face on the first face facing away from the user, and accordingly the belt body can be suppressed from sliding in contact against parts other than the first sliding contact face, such as the back or the like of the user. This suppresses the belt body from sliding in contact against the back or the like of the user and impeding of movement of the belt body.
(2) The above assisting device preferably further includes a first guide that prevents the belt body from falling off from the first sliding contact face. In this case, even in a case in which the user leans forward while twisting the upper body to the right or the left, thereby causing the belt body to shift position in the right or left direction, the belt body can be prevented from falling off from the first sliding contact face. As a result, the belt body can be prevented from falling off from the back frame and sliding in contact against parts other than the back frame, which would impede movement of the belt body or cause the direction in which the belt body extends to shift significantly from the taking-up direction of the actuator, and accordingly occurrence of loss of tensional force in the belt body that is a source of assisting force can be suppressed.
(3) Also, in the above assisting device, the first guide preferably is a wall portion protruding from the first face along both right and left sides of the first sliding contact face. In this case, the wall portion can prevent the belt body from falling off from the first sliding contact face.
(4) Also, the above assisting device may further include a protective member that is plate-like and that is provided on a side of the back frame toward the legs, in which a second face of the protective member facing away from the user includes a second sliding contact face over which the belt body slides in contact therewith. In this case, the belt body can be suppressed from sliding against the buttocks or the like below the waist of the user, which would impede movement of the belt body.
(5) Also, in the above assisting device, the protective member may include a second guide that prevents the belt body from falling off from the second sliding contact face. In this case, even in a case in which the user leans forward while twisting the upper body to the right or the left, thereby causing the belt body to shift position in the right or left direction, the belt body can be prevented from falling off from the second sliding contact face.

Also, in the above assisting device, it is conceivable to configure the second harness to be fixed to the knee by a belt or the like. However, if the second harness is configured to be fixed to the knee portion, there is concern that the second harness may become dispositioned due to the tensional force of the belt body or a significant change in the posture of the user. When dispositioning of the second harness occurs, this will result in the tensional force of the belt body that serves as the assisting force being weakened, and assisting force cannot be generated efficiently.
(6) In contrast, the second harness preferably includes a pair of lower leg belt portions of which upper end portions are connected to the belt body, a foot strap that connects lower end portions of the pair of lower leg belt portions and that also has a contact face that comes into contact with a sole of a foot of the user, and a holding strap that is provided on the pair of lower leg belt portions and that is fit on a knee of the user. In this case, the foot strap of the second harness is fit to the sole of the foot of the user. Accordingly, the tensional force of the belt body acts to pull up the sole of the foot of the user, thereby preventing the second harness from becoming dispositioned.
(7) The holding strap and the pair of lower leg belt portions are preferably provided so as to be relatively movable along an extending direction of the pair of lower leg belt portions. A combined length of the part of the belt body extending from the actuator and the second harness can be adjusted by the actuator. Thus, the second harness can be appropriately fit to users of various statures without adjusting the length of the pair of lower leg belt portions, by fitting with the position of the holding strap aligned with the position of the knee of the user, even without adjusting the length of the pair of lower leg belt portions.

### Details of Embodiments

Preferred embodiments will be described below with reference to the drawings.

### Overall Configuration of Assisting Device 10

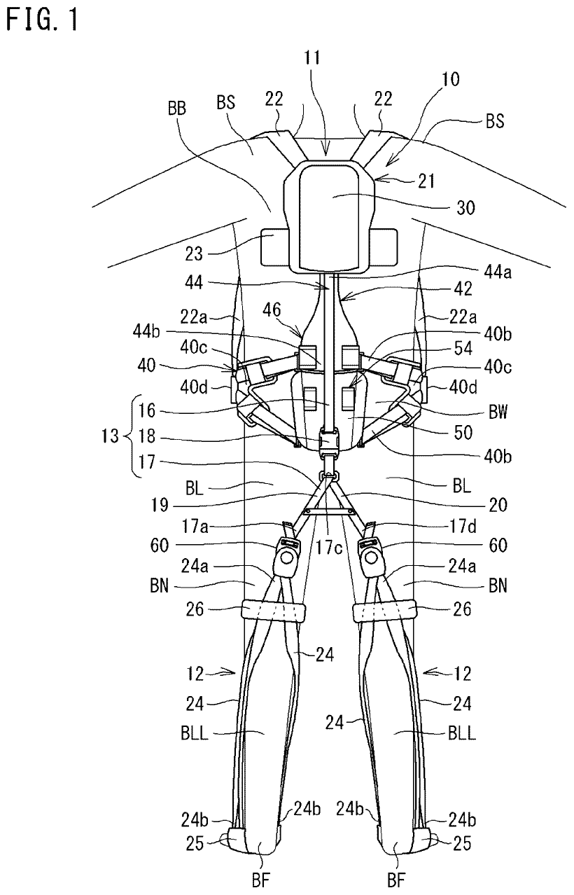

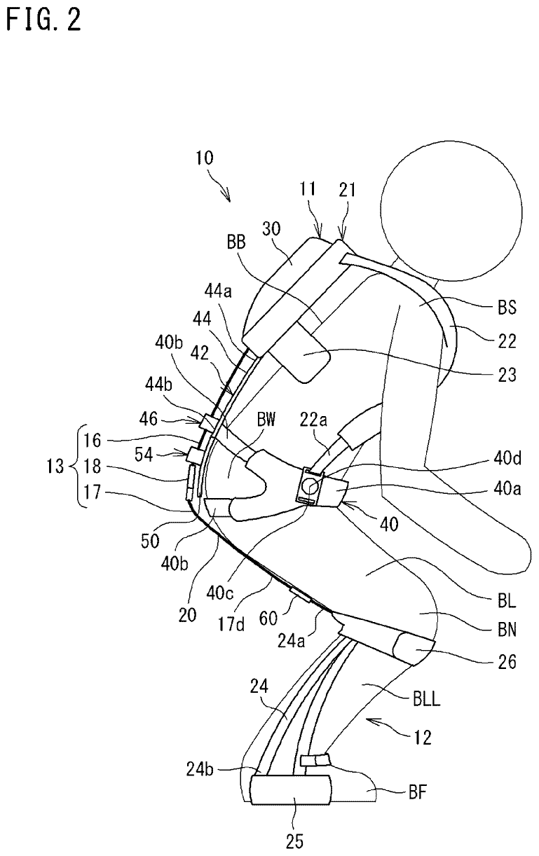

FIG. 1 is a rear view of an assisting device according to an embodiment, illustrating a state of attachment thereof to a body of a user. FIG. 2 is an explanatory diagram illustrating a state in which the user fitted with the assisting device is in a forward leaning posture (posture bent forward).

In an assisting device 10 of the present disclosure, right and left refer to the right and left of the user in an upright standing posture fitted with the assisting device 10, front and back refer to the front and back of the user, and up and down refer to the up and down of the user. Up is the side toward the head of the user and down is the side toward the legs of the user.

The assisting device 10 according to the present embodiment includes one first harness 11, two second harnesses 12, one third harness 40, and a belt body 13. The first harness 11 is fit on right and left shoulders BS of the user (person). It is sufficient for the first harness 11 to be fit on at least the shoulder BS of the user, and may have a form other than that illustrated in the drawings. The second harnesses 12 are fit on right and left legs BL of the user. In the present disclosure, the second harnesses 12 are fit on lower legs BLL of the legs BL. The second harness 12 on the left side and the second harness 12 on the right side have the same configuration. The third harness 40 is fit on a waist BW of the user.

The first harness 11 has a base 21, a pair of right and left shoulder belts 22, and a cushioning member 23. The base 21 includes a control box 30 that houses a control unit 15 and so forth, which will be described later. The base 21 is in a state of being carried on the back of the user by the pair of shoulder belts 22. The pair of shoulder belts 22 are provided on an upper portion of the base 21 (control box 30). A distal end portion 22a of each of the pair of shoulder belts 22 is connected to the third harness 40. The lengths of the shoulder belts 22 are adjustable. By adjusting the lengths of the shoulder belts 22, the base 21 is in a state of being fixed to a back BB of the user via the cushioning member 23.

The cushioning member 23 is interposed between the back BB and the control box 30, and suppresses the back BB from coming into direct contact with the control box 30. The cushioning member 23 is made of a sponge, a structure with a mesh sheet attached to the surface thereof, or the like. The structure is a member having cushioning properties, which is obtained by attaching a mesh sheet to a framework formed by assembling spring wire material into a predetermined three-dimensional shape.

The first harness 11 is fit to the shoulders BS so as not to move in the front-rear, right-left, or up-down directions. The first harness 11 may include, for example, a hard member as a part to run over the shoulders BS.

Each of the pair of second harnesses 12 includes a pair of lower leg belt portions 24, a foot strap 25, and a holding strap 26. The pair of lower leg belt portions 24 are strap-like members made of a non-elastic material. The pair of lower leg belt portions 24 are fit along the lower legs BLL. Upper end portions 24a of the pair of lower leg belt portions 24 are connected to the belt body 13 (described later) extending from the control box 30.

The foot strap 25 connects lower end portions 24b of the pair of lower leg belt portions 24 to each other. A foot BF of the user is placed in the foot strap 25. The holding strap 26 is a strap-like member made of fabric or the like that is flexible, and is provided to the pair of lower leg belt portions 24. The holding strap 26 is fit to a knee BN. Thus, the holding strap 26 holds the pair of lower leg belt portions 24 at the position of the knee BN.

Fitting each part of the second harnesses 12 to the lower legs BLL of the user as described above fixes the second harnesses 12 so as not to move in the front-rear, right-left, or up-down directions, relative to the lower legs BLL of the user. The second harnesses 12 will be described in detail later.

The third harness 40 is a strap-like member made of a fabric or the like that is flexible. Both ends of the third harness 40 are provided with retaining members such as buckles, hook-and-loop fasteners, or the like, which are omitted from illustration. In a state in which the third harness 40 is wrapped around the waist BW, both ends of the third harness 40 are retained by the retaining members. Thus, the third harness 40 is fit so as not to move in the front-back, right-left, or up-down directions relative to the waist BW.

The third harness 40 includes a front belt portion 40a, a pair of rear belt portions 40b, and a pair of connecting portions 40c. The front belt portion 40a is a part of the third harness 40 that is situated on the front side of the user when the third harness 40 is fit to the waist BW. The pair or rear belt portions 40b are parts of the third harness 40 that are situated on the rear side of the user when the third harness 40 is fit to the waist BW. The pair of connecting portions 40c are parts at which both ends of the front belt portion 40a and both ends of the pair of rear belt portions 40b are connected to each other. The connecting portions 40c are situated on the right and left sides of the waist BW. The positions of the connecting portions 40c are positions that substantially coincide with rotation axes of the thighs of the user.

The pair of rear belt portions 40b are disposed on an upper side portion of the waist BW and a lower side portion of the waist BW. This prevents the third harness 40 from shifting in the up-down direction relative to the waist BW when the user changes postures. The right and left connecting portions 40c are provided with connecting fittings 40d. The connecting fittings 40d are members for connecting the distal end portions 22a of the pair of shoulder belts 22 together. That is to say, the pair of shoulder belts 22 are connected to the third harness 40 at the positions of the connecting portions 40c.

The belt body 13 is provided along the back side (back BB) of the user. The belt body 13 connects the first harness 11 and the second harnesses 12 together. The belt body 13 has a first belt 16, a second belt 17, and a connecting member 18. The first belt 16 is provided on an upper body side of the user. The second belt 17 is provided on a lower body side of the user. The connecting member 18 connects the first belt 16 and the second belt 17 together. Each of the first belt 16 and the second belt 17 is elongated and has flexibility. The connecting member 18, which will be described later, is configured including, for example, a rectangular annular body called a “flat ring” or a “square ring”, and a fastener such as a buckle.

The first belt 16 and the second belt 17 are strap-like members made of cloth or leather, and are capable of flexing to fit the shape of the body. Note that the first belt 16 and the second belt 17 may be cord-like belts (wire-like members). The first belt 16 and the second belt 17 according to the present disclosure are non-elastic members. That is to say, the first belt 16 and the second belt 17 have a property of not readily stretching or not stretching at all in a longitudinal direction.

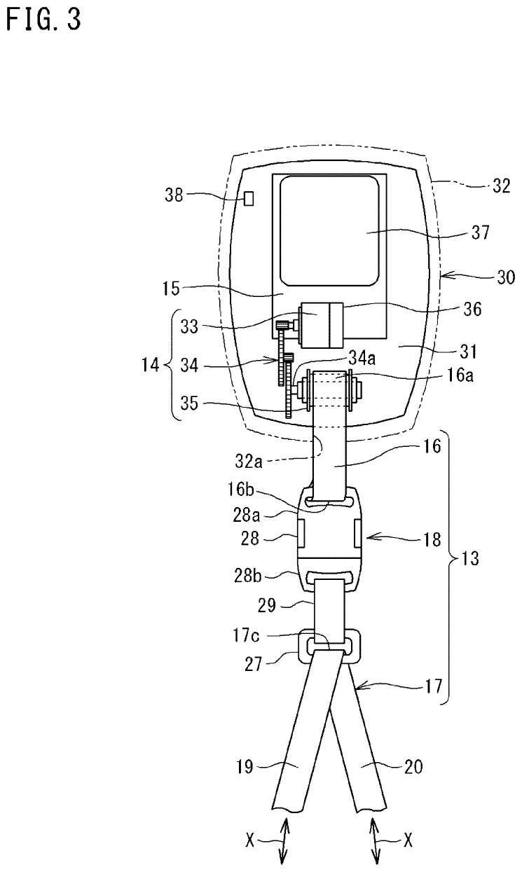

FIG. 3 is an enlarged view of principal portions of a rear face of the assisting device 10. In FIG. 3, inside of the control box 30 is illustrated. Also, to facilitate understanding, FIG. 3 illustrates the control box 30 and the inside thereof, as well as a portion of the belt body 13, and omits other parts. In addition to the above-mentioned first harness 11, second harnesses 12, third harness 40, and belt body 13, the assisting device 10 also includes an actuator 14, the control unit 15, a battery 37, and a sensor 38. The actuator 14, the control unit 15, the battery 37, and the sensor 38 are housed in the control box 30 which is a casing. The control box 30 has a back plate 31 and a cover 32 that covers the back plate 31. In FIG. 3, the cover 32 is illustrated in hidden outline (a long dashed double-short dashed line). The cover 32 has an opening (notch) 32a at a lower end portion thereof. The first belt 16 passes through the opening 32a.

The actuator 14 enables a portion of the belt body 13 to be taken up and fed out. In other words, the actuator 14 extends and retracts the belt body 13 between the first harness 11 and the second harnesses 12. The actuator 14 has a motor 33, a reduction gear unit 34, and a drive pulley 35. The motor 33 is a brushless DC motor. The motor 33 rotates at a predetermined torque and a predetermined number of revolutions based on control commands given by the control unit 15. Moreover, the motor 33 can rotate forward and backward based on control commands.

Parameters relating to rotation of the motor 33, such as rotational angle, rotational speed, number of revolutions, and so forth, are detected by a rotation detector 36. The rotation detector 36 is provided to the motor 33. The rotation detector 36 according to the present disclosure is a rotary encoder, but may be a Hall sensor or a resolver. Output of the rotation detector 36 is provided to the control unit 15.

The reduction gear unit 34 is made up of a plurality of gears. The reduction gear unit 34 reduces the number of revolutions of the motor 33, and rotates an output shaft 34a of the reduction gear unit 34. The drive pulley 35 is connected to the output shaft 34a, so as to be integrally rotatable therewith. One end portion 16a side of the first belt 16 is fixed to the drive pulley 35. When the drive pulley 35 rotates in one direction due to forward rotation of the motor 33, the first belt 16 is taken up by the drive pulley 35. When the drive pulley 35 rotates in the other direction due to reverse rotation of the motor 33, the first belt 16 is fed out from the drive pulley 35. Thus, the actuator 14 can take up and feed out the first belt 16, which is a portion of the belt body 13.

The control unit 15 is made up of, for example, a microcomputer. The control unit 15 has a function of controlling the actuator 14 based on output of the rotation detector 36 and output of the sensor 38. Processing performed by the control unit 15 will be described later.

The sensor 38 includes, for example, an acceleration sensor. The output of the sensor 38 is given to the control unit 15. The sensor 38 may be configured with one sensor unit, or alternatively may be configured with a plurality of sensor units. Further, the sensor 38 may be an inclination sensor, a gyro sensor, or a combination of these, other than an acceleration sensor. Also, the sensor 38 may be provided outside of the control box 30. The battery 37 supplies power to each part of the assisting device, such as the control unit 15, the motor 33, and so forth.

As described above, the belt body 13 includes the first belt 16, the second belt 17, and the connecting member 18. One end portion 16a side of the first belt 16 is wound on and fixed to the drive pulley 35. The other end portion 16b side of the first belt 16 is fixed to the connecting member 18. When the first belt 16 is taken up by the drive pulley 35, the connecting member 18 is pulled up. When the connecting member 18 is forcibly pulled down, the first belt 16 is fed out (pulled out) from the drive pulley 35. There is a correlation between the amount of the first belt 16 taken up or the amount thereof fed out (amount pulled out) from the drive pulley 35 and the amount of rotation of an output shaft of the motor 33. Accordingly, the amount of the first belt 16 taken up or the amount thereof fed out can be obtained based on the parameters related to the rotation of the motor 33.

As illustrated in FIG. 3, the connecting member 18 includes an annular body 27 and a fastener (buckle) 28. The fastener 28 has a first member 28a and a second member 28b. The first member 28a and the second member 28b are separable and connectable. The first member 28a is attached to the other end portion 16b of the first belt 16. The second member 28b and the annular body 27 are connected by a short belt 29. The second belt 17 is passed through the annular body 27.

The second belt 17 is folded back at the annular body 27 and thus hooked on the annular body 27. The annular body 27 supports the second belt 17 that is folded back. As a result, the second belt 17 is supported by the annular body 27 without being fixed to the annular body 27. Thus, the second belt 17 is movable in both directions in the longitudinal direction thereof (directions of arrows X in FIG. 3).

As illustrated in FIG. 1, the second belt 17 is attached to the second harnesses 12. The second belt 17 is made up of a single strap-like member. One end portion 17a of the second belt 17 is connected to the second harness 12 on the left. The other end portion 17d of the second belt 17 is connected to the second harness 12 on the right. An intermediate portion 17c of the second belt 17 is hooked onto the connecting member 18.

The second belt 17 includes a left leg belt portion 19 and a right leg belt portion 20 in addition to the intermediate portion 17c. The left leg belt portion 19 is a part of the second belt 17 from the connecting member 18 (intermediate portion 17c) to the second harness 12 on the left. The right leg belt portion 20 is a part of the second belt 17 from the connecting member 18 (intermediate portion 17c) to the second harness 12 on the right. As described above, the second belt 17 is not fixed to the annular body 27, and accordingly the length of the left leg belt portion 19 and the length of the right leg belt portion 20 can be freely changed. Note however that the sum of the length of the left leg belt portion 19 and the length of the right leg belt portion 20 is constant. According to this configuration, the user is not restricted in walking, for example, by the second belt 17, and the user can walk comfortably.

The assisting device 10 according to the present embodiment further includes a holding body 42 and a protective member 50. The holding body 42 has a function of maintaining spacing between the first harness 11 and the third harness 40. As illustrated in FIG. 1 and FIG. 2, the holding body 42 includes a back frame 44. The back frame 44 connects the control box 30 of the first harness 11 and the rear belt portion 40b of the third harness 40 at approximately the middle of the back BB of the user. The back frame 44 is a plate-like member made of resin or metal. The back frame 44 is disposed between the belt body 13 and the user.

An upper end portion 44a of the back frame 44 is fixed to the control box 30. A lower end portion 44b of the back frame 44 is fixed to the rear belt portion 40b on the upper side thereof. Thus, the back frame 44 maintains spacing between the control box 30 and the rear belt portion 40b.

The protective member 50 is provided on the leg BL side (lower side) of the back frame 44. The protective member 50 is a plate-like member made of resin or metal. The protective member 50 is provided so as to extend downward from the lower end portion 44b of the back frame 44. The protective member 50 is also disposed between the belt body 13 and the user, in the same way as with the back frame 44. The holding body 42 and the protective member 50 will be described in detail later.

### Regarding Processing by Control Unit 15

As described above, the control unit 15 controls the actuator 14 based on the output of the rotation detector 36 and the output of the sensor 38. The control unit 15 can detect actions or posture of the user, based on the output of the sensor 38. Accordingly, the sensor 38 has a function as a detector for detecting the actions or posture of the user. For example, based on the output of the sensor 38, detection of a state regarding whether the posture of the upper body is a forward leaning posture or an upright standing posture, detection that the user is now in a crouched state, and so forth, as the posture of the user, can be performed.

Also, there is a correlation between the amount of the belt body 13 taken up by and the amount thereof fed out from the drive pulley 35 by the motor 33, and the posture of the user. Accordingly, the control unit 15 can estimate the posture of the user based on the rotational angle of the motor 33 detected by the rotation detector 36. Thus, it can be said that the rotation detector 36 is a sensor for detecting the posture and actions of the user.

The control unit 15 generates a control command based on at least one of the output of the rotation detector 36 and the output of the sensor 38, and provides the control command to the actuator 14 (motor 33). Accordingly, the control unit 15 controls the actuator 14. The actuator 14 operates based on control commands to take up and feed out the belt body 13, as well as to perform temporary suspension thereof, and so forth. Thus, the actuator 14 is controlled in accordance with the posture of the user.

When the assisting device 10 is fit on the user, the motor 33 is controlled to constantly operate in a direction to take up the belt body 13 (to generate torque) with a force that is weaker than a case in which an assisting force is being generated. Thus, a weak tensional force is generated in the belt body 13, and the belt body 13 does not become slack.

For example, when the user changes from an upright standing posture to a forward leaning posture, tensional force is generated in the belt body 13 due to the change in posture. In this case, the motor 33 is forced to rotate (the motor 33 spins free) under the tensional force of the belt body 13 caused by the change in position, and the belt body 13 is fed out without the power of the actuator 14. Alternatively, when the posture starts to change to a forward leaning posture, the actuator 14 operates, i.e., the motor 33 is rotationally driven, and the belt body 13 is fed out.

Conversely, when the user changes from a forward leaning posture to an upright standing posture, the belt body 13 tends to become slack due to the change in posture. In this case, when the posture starts to change to the upright standing posture, the actuator 14 operates to maintain the tensional force acting on the belt body 13, i.e., the motor 33 is driven to rotate and the belt body 13 is taken up.

In this way, the belt body 13 is taken up or fed out in accordance with change in the posture of the user. When taking up or feeding out is performed, the motor 33 actively or passively rotates at a predetermined rotational angle. The rotational angle at this time is detected by the rotation detector 36. Thus, the amount of operation of the actuator 14 (motor 33) when the belt body 13 is taken up or fed out, due to change in the posture of the user, is detected by the rotation detector 36.

Based on the output of the rotation detector 36, the control unit 15 obtains the amount of operation of the actuator 14 (the rotational angle of the motor 33) when the belt body 13 is taken up or fed out due to change in the posture of the user, and controls the actuator 14 based on the amount of operation to provide assisting force to the user.

### Regarding Assisting Force by Assisting Device 10

The assisting device 10 according to the present embodiment applies an assisting force to the user in accordance with change in the posture of the user. When the first belt 16 is taken up by the drive pulley 35 by (the motor 33 of) the actuator 14, the connecting member 18 pulls the second belt 17 up toward the actuator 14 side, i.e., upward. The second belt 17 has both end portions 17a and 17d thereof attached to the right and left second harnesses 12. The second harnesses 12 are fixed to the lower legs BLL. Accordingly, when the first belt 16 is taken up by the drive pulley 35, tensional force acts on the first belt 16 and the second belt 17. This tensional force acts as the assisting force (supplementary force) on the user. That is to say, the actuator 14 generates the assisting force between the first harness 11 and the second harnesses 12.

In a case in which the user changes from an upright standing posture to a forward leaning posture, the belt body 13 is fed out without the power of the actuator 14. This enables the user to naturally assume a forward leaning posture. Assuming that the user changes his/her posture from the upright standing posture and maintains a posture at a predetermined angle leaning forward, the feeding out (unwinding) of the belt body 13 will be stopped. Note that starting and ending of the posture change can be detected by the rotation detector 36 or the sensor 38.

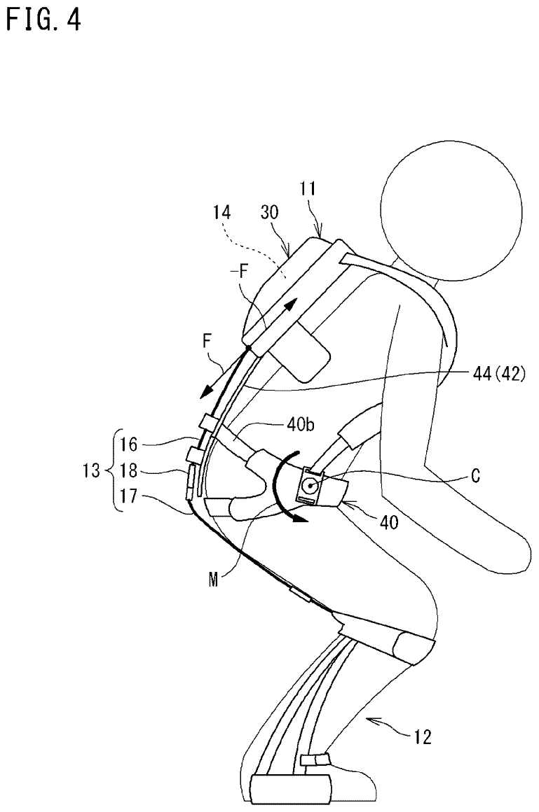

Conversely, when the user starts to change his/her posture from the forward leaning posture (posture bent forward) such as illustrated in FIG. 4 to the upright standing posture, the actuator 14 takes up the belt body 13 (first belt 16). As a result, tensional force F is generated in the belt body 13. This tensional force F generates a moment M that acts in a direction to make the upper body stand upright. Note that reaction force −F of the tensional force F is a force by which the actuator 14 acts to pull up the belt body 13. The moment M acts about the proximity of a rotation axis C of the thigh. This moment M enables the user to easily return from the forward leaning posture to the upright standing posture. Also, the assisting device 10 according to the present embodiment has the back frame 44 (holding body 42) that connects the control box 30 (first harness 11) and the third harness 40, and maintains the predetermined spacing therebetween, and accordingly the tensional force F (reaction force −F) acting between the control box 30 and the third harness 40 can be supported by the back frame 44, and the moment M can be generated efficiently while suppressing a load due to the tensional force F from excessively acting on the user.

The assisting device 10 according to the present embodiment generates the moment M described above, thereby reducing muscular load on the back muscles, quadriceps muscles, and so forth, when the user is in the posture bent forward, and thus can assist the user in performing work movements. As a result, the burden on the waist when in a posture bent forward is reduced, thereby enabling lower back pain to be suppressed.

### Regarding Holding Body 42 and Protective Member 50

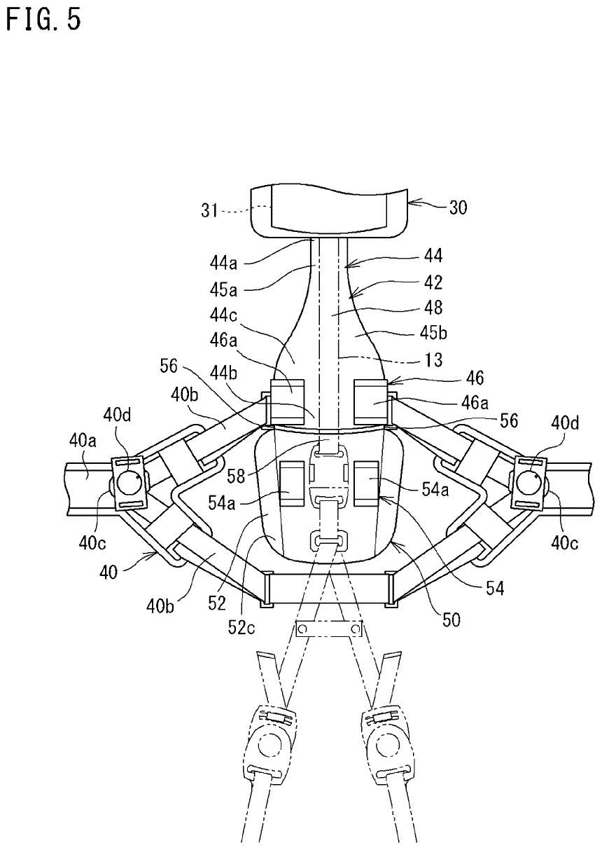

FIG. 5 is an enlarged view of principal portions of the rear face of the assisting device 10. In FIG. 5, the belt body 13 is indicated by a long dashed double-short dashed line. As described above, the back frame 44 of the holding body 42 is disposed between the belt body 13 and the user. The belt body 13 that extends from the control box 30 follows along an outer side face 44c of the back frame 44. The outer side face 44c (first face) is a face of the back frame 44 that faces away from the user.

The outer side face 44c of the back frame 44 includes a first sliding contact face 48. The first sliding contact face 48 is a face of the outer side face 44c with which the belt body 13 is in sliding contact. The first sliding contact face 48 spans the upper end portion 44a to the lower end portion 44b of the back frame 44. The first sliding contact face 48 has a smooth surface, so as not to impede movement of the belt body 13.

The back frame 44 has a narrow-width portion 45a on the upper end portion 44a side, and a broad-width portion 45b on the lower end portion 44b side. The width of the narrow-width portion 45a is substantially constant from the upper end portion 44a. That is to say, the narrow-width portion 45a is a part of the back frame 44 that has a constant width at the upper end portion 44a. The width of the narrow-width portion 45a is slightly wider than the width of the first sliding contact face 48. The broad-width portion 45b is connected to a lower end portion of the narrow-width portion 45a. The width of the broad-width portion 45b gradually increases from the part connected to the narrow-width portion 45a toward the lower end portion 44b.

In addition to the back frame 44, the holding body 42 includes a first guide 46. The first guide 46 is provided on the outer side face 44c and prevents the belt body 13 from falling off from the first sliding contact face 48. The first guide 46 has a pair of wall portions 46a. The pair of wall portions 46a are block-like members made of resin or the like. The pair of wall portions 46a are provided in the part of the broad-width portion 45b. The pair of wall portions 46a are provided side by side on the right and left, across a predetermined spacing. The pair of wall portions 46a protrude from the outer side face 44c along both the right and left sides of the first sliding contact face 48. The belt body 13 passes between the pair of wall portions 46a. Accordingly, the first sliding contact face 48 passes through a part of the outer side face 44c between the pair of wall portions 46a. The spacing between the pair of wall portions 46a is set to such a dimension that the belt body 13 can pass through.

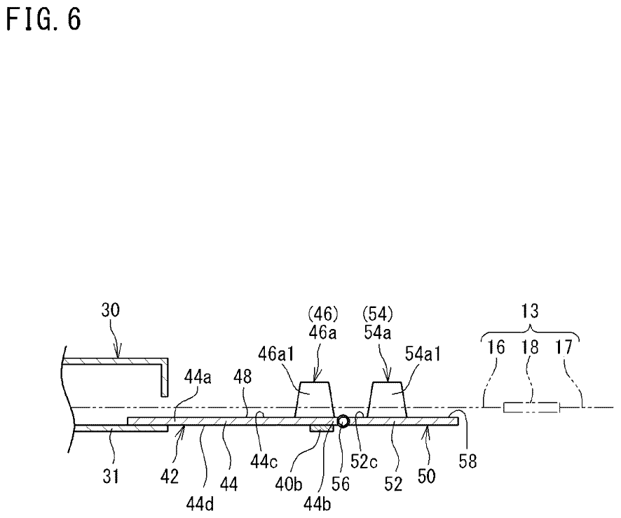

FIG. 6 is a schematic diagram illustrating a cross-section of the holding body 42 and the protective member 50. FIG. 6 illustrates a cross-section of the holding body 42 taken along the up-down direction at the center in the right-left direction. In FIG. 6, the belt body 13 (the first belt 16, the second belt 17, and the connecting member 18) is indicated by a long dashed double-short dashed line. As illustrated in FIG. 6, the rear belt portion 40b is fixed to the lower end portion 44b of the back frame 44. The rear belt portion 40b is fixed to an inner side face 44d of the back frame 44. Also, the upper end portion 44a of the back frame 44 is fixed to the back plate 31 of the control box 30. The pair of wall portions 46a prevent the belt body 13 from falling off from the first sliding contact face 48 by opposing faces 46a1. Projecting dimensions of the pair of wall portions 46a with respect to the outer side face 44c are set such that the connecting member 18 of the belt body 13 can be guided.

According to the above configuration, the holding body 42 has the back frame 44 that connects the first harness 11 and the third harness 40, and accordingly the distance between the first harness 11 that is fit to the back BB and the third harness 40 that is fit to the waist BW can be maintained without placing structures such as frames or the like on both right and left sides of the body of the user. As a result, the holding body 42 can be suppressed from impeding movements of the user.

Also, in the present embodiment, the back frame 44 has the first sliding contact face 48 on the outer side face 44c facing away from of the user, and thus the belt body 13 can be suppressed from sliding over parts other than the first sliding contact face 48, such as the back BB or the like of the user. This suppresses the belt body 13 from sliding in contact against the back BB or the like of the user and impeding of movement of the belt body 13.

Also, the holding body 42 according to the present embodiment includes the first guide 46, and accordingly even in a case in which the user leans forward while twisting the upper body to the right or the left, thereby causing the belt body 13 to shift position in the right or left direction, the belt body 13 can be prevented from falling off from the first sliding contact face 48. As a result, the belt body 13 can be prevented from falling off from the back frame 44 and sliding against parts other than the back frame 44, which would impede movement of the belt body 13 or cause the direction in which the belt body 13 extends to shift significantly from the taking-up direction of the actuator 14, or the like, and accordingly loss of tensional force in the belt body 13 that is the source of the assisting force can be suppressed.

As illustrated in FIG. 5 and FIG. 6, the protective member 50 includes a protective plate 52 and a second guide 54. The protective plate 52 is disposed between the belt body 13 and the user. Accordingly, the belt body 13 is provided along an outer side face 52c of the protective plate 52. The outer side face 52c (second face) is the face of the protective plate 52 that faces away from the user. A hinge 56 is provided between the protective plate 52 and the back frame 44. The hinge 56 connects the protective plate 52 and the back frame 44 so as to be swingable in the front-rear direction.

The outer side face 52c of the protective plate 52 includes a second sliding contact face 58. The second sliding contact face 58 is a face of the outer side face 52c with which the belt body 13 is in sliding contact. The second sliding contact face 58 has a smooth surface, so as not to impede movement of the belt body 13.

The second guide 54 is provided on the outer side face 52c and prevents the belt body 13 from falling off from the second sliding contact face 58. The second guide 54 has a pair of wall portions 54a. The pair of wall portions 54a are block-like members made of resin or the like. The pair of wall portions 54a are provided at approximately the middle in the up-down direction on the outer side face 52c. The pair of wall portions 54a are provided side by side on the right and left, across a predetermined spacing. The pair of wall portions 54a protrude from the outer side face 52c along both the right and left sides of the second sliding contact face 58. The belt body 13 passes between the pair of wall portions 54a. Accordingly, the second sliding contact face 58 passes through a part of the outer side face 52c between the pair of wall portions 54a. The spacing between the pair of wall portions 54a is set to a dimension such that the belt body 13 can pass through.

As illustrated in FIG. 6, the pair of wall portions 54a prevent the belt body 13 from falling off from the second sliding contact face 58 by opposing faces 54a1. Projecting dimensions of the pair of wall portions 54a with respect to the outer side face 52c are set such that the connecting member 18 of the belt body 13 can be guided.

The present embodiment includes (the protective plate 52 of) the protective member 50 that has the second sliding contact face 58 against which the belt body 13 slides, on the outer side face 52c facing away from the user, thereby suppressing the movement of the belt body 13 from being impeded by the belt body 13 sliding in contact against the buttocks or other parts of the user below the waist.

Also, in a case in which the user assumes a forward leaning posture, tensional force is applied to the belt body 13 in a state of being aligned with the back BB and buttocks of the user. Accordingly, regarding the belt body 13, the back BB and the buttocks are pressed by the belt body 13. Now, in the present embodiment, the protective plate 52 is swingably attached to the lower end portion 44b of the back frame 44, such that when the user changes his/her posture from an upright standing posture to a forward leaning posture, the protective plate 52 swings in accordance with the posture of the user, and the back frame 44 and the protective plate 52 can be aligned with the back BB and the buttocks of the user. As a result, the belt body 13 can be brought into appropriate sliding contact with the first sliding contact face 48 and the second sliding contact face 58.

Further, the protective member 50, like the holding body 42, also includes the second guide 54, and accordingly even in a case in which the user leans forward while twisting the upper body to the right or the left, thereby causing the belt body 13 to shift position in the right or left direction, the belt body 13 can be prevented from falling off from the second sliding contact face 58.

### Regarding Second Harnesses 12

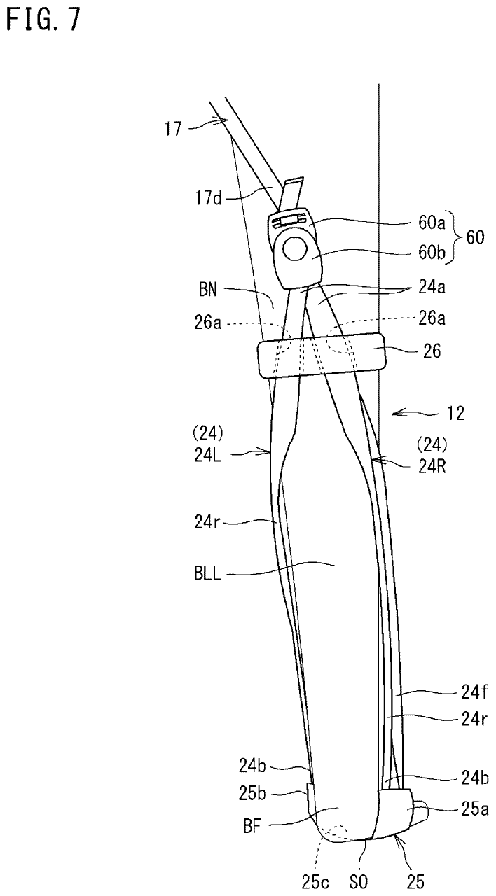

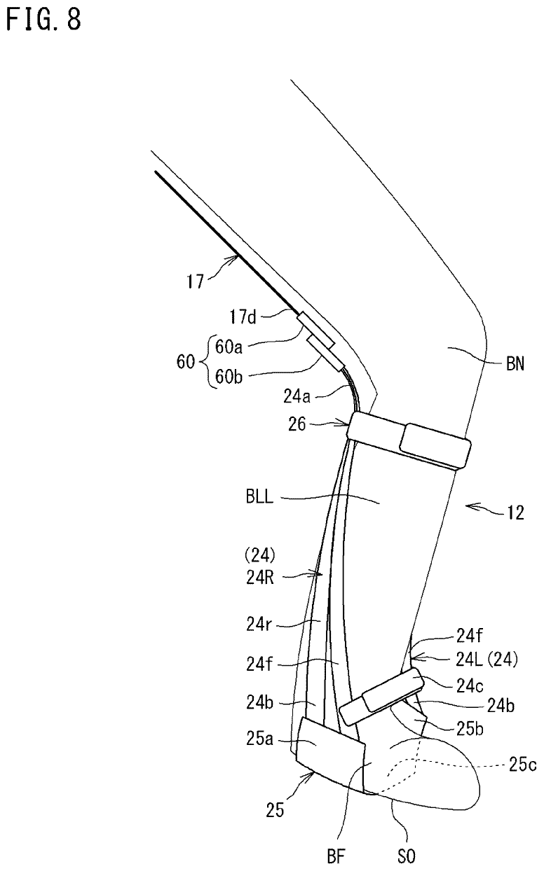

FIG. 7 is a diagram of the second harness 12 in a state of being fit on the right leg of the user, as viewed from the rear face, and FIG. 8 is a diagram of the second harness 12 in a state of being fit on the right leg of the user, as viewed diagonally from the front. The second harnesses 12 have the same configuration on the right and left sides. Accordingly, in the following description, the right second harness 12 will be described.

As described above, the second harness 12 includes the pair of lower leg belt portions 24, the foot strap 25, and the holding strap 26. The upper end portions 24a of the pair of lower leg belt portions 24 are connected to the second belt 17 (belt body 13). More specifically, a connecting fitting 60 is provided between the upper end portions 24a of the pair of lower leg belt portions 24 and the other end portion 17d of the second belt 17 of the belt body 13. The connecting fitting 60 includes a buckle or the like. The connecting fitting 60 is disposed on a back side of the knee BN. The connecting fitting 60 has a first member 60a and a second member 60b. The first member 60a and the second member 60b are separable and connectable. The first member 60a is attached to the other end portion 17d of the second belt 17. The upper end portions 24a of the pair of lower leg belt portions 24 are attached to the second member 60b. Thus, the connecting fitting 60 separably connects the pair of lower leg belt portions 24 and the belt body 13.

The pair of lower leg belt portions 24 separate and extend downward from the connecting fitting 60 on the back side of the knee BN to both the right and the left sides of the lower leg BLL. As described above, the lower end portions 24b of the pair of lower leg belt portions 24 are connected by the foot strap 25. Of the pair of lower leg belt portions 24, a right lower leg belt portion 24R that runs along the right side of the lower leg BLL is connected to one end 25a of the foot strap 25. Of the pair of lower leg belt portions 24, a left lower leg belt portion 24L that runs along the left side of the lower leg BLL is connected to the other end 25b of the foot strap 25.

Also, each of the pair of lower leg belt portions 24 includes a front belt 24f and a rear belt 24r. A lower end portion of the front belt 24f of the right lower leg belt portion 24R is connected to a front end of the one end 25a of the foot strap 25. A lower end portion of the rear belt 24r of the right lower leg belt portion 24R is connected to a rear end of the one end 25a of the foot strap 25. A lower end portion of the front belt 24f of the left lower leg belt portion 24L is connected to a front end of the other end 25b of the foot strap 25. A lower end portion of the rear belt 24r of the left lower leg belt portion 24L is connected to a rear end of the other end 25b of the foot strap 25.

The foot strap 25 is a strap-like member that passes over the sole SO of the foot of the user in the right-left direction. The foot strap 25 has a contact face 25c with which the sole SO of the foot of the user comes into contact. Thus, the leg of the user is placed on the foot strap 25.

The front belt 24f of the right lower leg belt portion 24R and the front belt 24f of the left lower leg belt portion 24L are connected by a connecting strap 24c. The connecting strap 24c is provided connecting the lower end portions of both belts 24f, so as to follow along an upper face of the foot BF of the user. This prevents the foot strap 25 from falling off from the foot BF of the user.

As described above, the holding strap 26 is fit to the knee BN. The holding strap 26 in the present embodiment is fit to a lower portion of the knee BN. The holding strap 26 is provided with retaining members, such as hook-and-loop fasteners or the like, on both ends thereof. Both ends of the holding strap 26 are fastened by the retaining members in a state in which the holding strap 26 is wrapped around the knee BN. Thus, the holding strap 26 is fit to the knee BN.

The holding strap 26 is provided with a pair of holes 26a. The pair of holes 26a pass through the holding strap 26 in the up-down direction. The pair of lower leg belt portions 24 pass through the pair of holes 26a. Thus, the holding strap 26 is provided on the pair of lower leg belt portions 24. The pair of lower leg belt portions 24 movably pass through the pair of holes 26a. This pair of holes 26a allows the holding strap 26 and the pair of lower leg belt portions 24 to move relatively in an extending direction of the pair of lower leg belt portions 24.

Now, the combined length of the part of the belt body 13 extending from the actuator 14 and the second harness 12 can be adjusted by the actuator 14. Also, the holding strap 26 and the pair of lower leg belt portions 24 can move relative to each other in the extending direction of the pair of lower leg belt portions 24, and accordingly the distance between the foot strap 25 and the holding strap 26 can be adjusted in accordance with the height of the knee BN of the user. Thus, the second harnesses 12 can be appropriately fit to users of various statures without adjusting the length of the pair of lower leg belt portions 24, by fitting with the positions of the holding straps 26 aligned with the positions of the knees BN of the user, even without adjusting the length of the pair of lower leg belt portions 24.

In the assisting device 10 according to the present embodiment, it is conceivable to configure the second harnesses 12 to be fixed to the knees BN by belts or the like. However, if the second harness 12 is configured to be fixed to the knee portion alone, there is concern that the second harnesses 12 may become dispositioned due to the tensional force of the belt body 13 or a significant change in the posture of the user. Dispositioning of the second harness 12 will result in the tensional force of the belt body 13 that serves as the assisting force being weakened, and assisting force cannot be generated efficiently.

With regard to this point, in the present embodiment, the second harnesses 12 each is preferably provided with the pair of lower leg belt portions 24 of which the upper end portions 24a are connected to the belt body 13, the foot strap 25 that connects the lower end portions 24b of the pair of lower leg belt portions 24 and also has the contact face 25c with which the sole SO of the foot of the user comes into contact, and the holding strap 26 that is provided on the pair of lower leg belt portions 24 and fit to the knee BN of the user. In this case, the foot strap 25 of the second harness 12 is fit to the sole SO of the foot of the user. Therefore, the tensional force of the belt body 13 acts to pull up the sole SO of the foot of the user, thereby preventing the second harness 12 from becoming dispositioned. As a result, assisting force can be generated efficiently.

### Other Embodiments

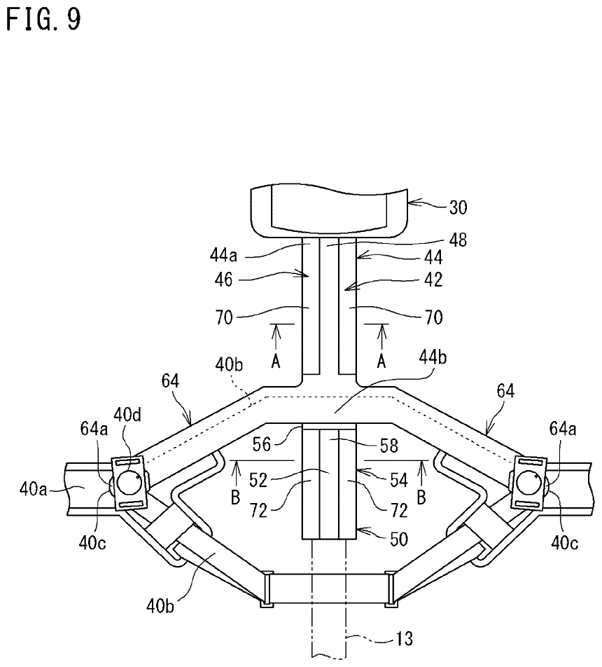

FIG. 9 is a diagram illustrating a holding body 42 according to another embodiment. As illustrated in FIG. 9, the present embodiment differs from the above-described embodiment with respect to a point that the width of the back frame 44 is constant, and a point that the holding body 42 includes a pair of waist frames 64.

In the present embodiment, the width of the back frame 44 is approximately constant from the upper end portion 44a to the lower end portion 44b. Accordingly, the back frame 44 has a rectangular shape that is elongated in the up-down direction. The first guide 46 in the present embodiment is provided along the right and left edges of the back frame 44.

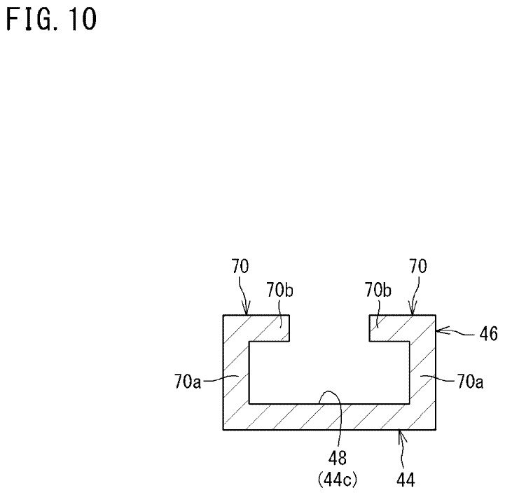

FIG. 10 is a cross-sectional view taken in the direction of arrows on line A-A in FIG. 9. As illustrated in FIG. 10, the first guide 46 has a pair of wall portions 70. The pair of wall portions 70 are formed integrally with the back frame 44. The pair of wall portions 70 extend in the up-down direction along the right and the left edges of the back frame 44. Accordingly, the pair of wall portions 70 extend along both the right and the left sides of the first sliding contact face 48. The pair of wall portions 70 protrude from the first sliding contact face 48. Each of the pair of wall portions 70 has a wall body 70a that protrudes from the first sliding contact face 48, and a protruding portion 70b that protrudes inward from a distal end of the wall body 70a.

The pair of wall portions 70 prevent the belt body 13 from falling off from the first sliding contact face 48 by the wall bodies 70a and the protruding portions 70b. That is to say, the belt body 13 moves through a space surrounded by the back frame 44 and the pair of wall portions 70. This enables the belt body 13 to be prevented from falling off from the first sliding contact face 48 more effectively.

Returning to FIG. 9, the pair of waist frames 64 extend in the right-left direction from the lower end portion 44b of the back frame 44. The pair of waist frames 64 are formed of an elastically deformable resin or the like. For example, in a case in which the back frame 44 is made of resin, the pair of waist frames 64 are provided integrally with the back frame 44. Also, in a case in which the back frame 44 is made of metal, the pair of waist frames 64 are fixed to the back frame 44 by connecting members such as screws, rivets, or the like. In the present embodiment, the pair of waist frames 64 are provided integrally with the back frame 44.

The pair of waist frames 64 extend along the rear belt portion 40b on the upper side. The pair of waist frames 64 are fixed to the rear belt portion 40b on the upper side. End portions 64a of the pair of waist frames 64 extend to the connecting portions 40c. The pair of waist frames 64 fixed to the rear belt portion 40b on the upper side are curved together with the upper rear belt portion 40b and wrapped around the waist BW of the user, thereby being fit to the waist BW. Thus, the back frame 44 is connected to the pair of waist frames 64 that are wrapped around the waist BW, such that moment M (FIG. 4) can be generated more efficiently as compared to the case in which the back frame 44 is fixed only to the rear belt portion 40b of the third harness 40, which is a strap-like member made of fabric or the like, as in the above embodiment.

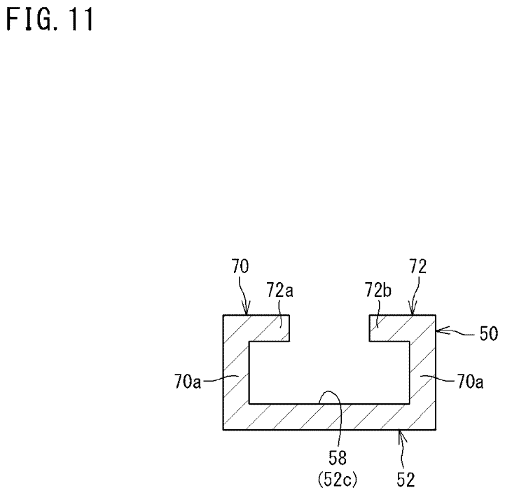

Also, the protective plate 52 of the protective member 50 in the present embodiment has a rectangular shape that is elongated in the up-down direction. The second guide 54 is provided along the right and the left edges of the protective plate 52. FIG. 11 is a cross-sectional view taken in the direction of arrows on line B-B in FIG. 9. As illustrated in FIG. 11, the second guide 54 has a pair of wall portions 72. The pair of wall portions 72 are formed integrally with the protective plate 52. The pair of wall portions 72 extend in the up-down direction along the right and the left edges of the protective plate 52. Accordingly, the pair of wall portions 72 extend along both the right and the left sides of the second sliding contact face 58. The pair of wall portions 72 protrude from the second sliding contact face 58. Each of the pair of wall portions 72 has a wall body 72a that protrudes from the second sliding contact face 58, and a protruding portion 72b that protrudes inward from a distal end of the wall body 72a.

The pair of wall portions 72 prevent the belt body 13 from falling off from the second sliding contact face 58 by the wall bodies 72a and the protruding portions 72b. That is to say, the belt body 13 moves through space surrounded by the protective plate 52 and the pair of wall portions 72. This enables the belt body 13 to be prevented from falling off from the second sliding contact face 58 more effectively.

### Others

The embodiments disclosed herein are exemplary in all respects and not restrictive. In each of the above embodiments, a case is exemplified in which the back frame 44 and the protective member 50 are connected by the hinge 56, but the back frame 44 and the protective member 50 may be formed integrally. Also, in each of the above embodiments, a case is exemplified in which the protective member 50 is provided, but the protective member 50 does not have to be provided. In this case, the weight of the assisting device 10 can be reduced. However, providing the protective member 50 enables movement of the belt body 13 to be kept from being impeded due to the belt body 13 coming into sliding contact with the buttocks or the like below the waist, as described above.

Also, in each of the above embodiments, a case is exemplified in which the holding straps 26 of the second harnesses 12 are attached to the lower portions of the knees BN, but the holding straps 26 may be attached to the upper portions of the knees BN, or may be in the form of supporters that are fit from the upper portions to the lower portions of the knees BN.

The scope of the present invention is not limited to the embodiments discussed above, and includes all changes made within the scope of equivalents to the configurations set forth in the claims.

### DESCRIPTION OF THE REFERENCE NUMERALS

10 Assisting device
11 First harness
12 Second harness
13 Belt body
14 Actuator
15 Control unit
16 First belt
16a One end portion
16b Other end portion
17 Second belt
17a One end portion
17c Intermediate portion
17d Other end portion
18 Connecting member
19 Left leg belt portion
20 Right leg belt portion
21 Base
22 Shoulder belt
22a Distal end portion
23 Cushioning member
24 Lower leg belt portion
24L Left lower leg belt portion
24R Right lower leg belt portion
24a Upper end portion
24b Lower end portion
24c Connecting strap
24f Front belt
24r Rear belt
25 Foot strap
25a One end
25b Other end
25c Contact face
26 Holding strap
26a Hole portion
27 Annular body
28 Fastener
28a First member
28b Second member
29 Short belt
30 Control box
31 Back plate
32 Cover
32a Opening
33 Motor
34 Reduction gear unit
34a Output shaft
35 Drive pulley
36 Rotation detector
37 Battery
38 Sensor
40 Third attachment
40a Front belt portion
40b Rear belt portion
40c Connecting portion
40d Connecting fitting
42 Holding body
44 Back frame
44a Upper end portion
44b Lower end portion
44c Outer side face
44d Inner side face
45a Narrow-width portion
45b Broad-width portion
46 First guide
46a Wall portion
46a1 Opposing faces
48 First sliding contact face
50 Protective member
52 Protective plate
52c Outer side face
54 Second guide
54a Wall portion
54a1 Opposing faces
56 Hinge
58 Second sliding contact face
60 Connecting fitting
60a First member
60b Second member
64 Waist frame
64a End portion
70 Wall portion
70a Wall body
70b Protruding portion
72 Wall portion
72a Wall body
72b Protruding portion

1. An assisting device comprising:
a first harness that is fit on at least shoulders of a user;
a second harness that is fit on each of right and left legs of the user;
a third harness that is fit on a waist of the user;
a belt body that is provided along a back of the user, spanning the first harness and the second harness;
an actuator that is provided in the first harness and that enables a portion of the belt body to be taken up and fed out; and
a back frame that connects the first harness and the third harness at a middle of the back of the user, and maintains a spacing therebetween, wherein
a first face of the back frame that faces away from the user includes a first sliding contact face over which the belt body slides in contact therewith,
the assisting device further including a first guide that prevents the belt body from falling off from the first sliding contact face, and
the first guide is a wall portion protruding from the first face along both right and left sides of the first sliding contact face.

2-3. (canceled)

4. The assisting device according to claim 1, further comprising a protective member that is plate-like and that is provided on a side of the back frame toward the legs, wherein a second face of the protective member facing away from the user includes a second sliding contact face over which the belt body slides in contact therewith.

5. The assisting device according to claim 4, wherein the protective member includes a second guide that prevents the belt body from falling off from the second sliding contact face.

6. The assisting device according to claim 1, wherein the second harness includes
a pair of lower leg belt portions of which upper end portions are connected to the belt body,
a foot strap that connects lower end portions of the pair of lower leg belt portions and that also has a contact face that comes into contact with a sole of a foot of the user, and
a holding strap that is provided on the pair of lower leg belt portions and that is fit on a knee of the user.

7. The assisting device according to claim 6, wherein the holding strap and the pair of lower leg belt portions are provided so as to be relatively movable along an extending direction of the pair of lower leg belt portions.
